(19) United States
(12) Patent Application Publication
(10) Pub. No.: US 2014/0129537 A1
(43) Pub. Date: May 8, 2014

(54) Topic search based method and apparatus for facilitating social contact in a network of users

(71) Applicant: Mary A. Spio, Orlando, FL (US)

(72) Inventor: Mary A. Spio, Orlando, FL (US)

(21) Appl. No.: 14/091,283

(22) Filed: Nov. 26, 2013

Related U.S. Application Data
(63) Continuation-in-part of application No. 13/900,450, filed on May 22, 2013, now abandoned.
(60) Provisional application No. 61/650,237, filed on May 22, 2012.

(51) Int. Cl. G06F 17/30

(52) U.S. Cl. CPC G06F 17/30864
USPC 707/706; 707/722

(57) ABSTRACT

A method, apparatus for facilitating social contact in a network of users is disclosed. The method and apparatus permits topic searching for events and activities, and presents the results of such topic searches in conjunction with information identifying other people in the network whose demographic and desired contact information match that of the person making the search.

### CROSS-REFERENCE TO RELATED APPLICATIONS

This application is a continuation-in-part of U.S. patent application Ser. No. 13/900,450, entitled “LIFESTYLE OPTIMIZED SEARCH ENGINE,” by Mary A. Spio, filed May 22, 2013, which application claims benefit of U.S. Provisional Patent Application No. 61/650,237, entitled “METHOD AND APPARATUS FOR INTENT-BASED SEARCH MATCHING AND SOCIAL COMMERCE,” by Mary A. Spio, filed May 22, 2012, both of which application are hereby incorporated by reference herein.

### BACKGROUND OF THE INVENTION

1. Field of the Invention

The present invention relates to systems and methods for facilitating social contact between users, and in particular to such systems and methods based on topic searches.

2. Description of the Related Art

The United States has approximately 112 million single adults—more than any other nation in the world except for China and India—and a number that surpasses that of the total national population of all except eleven of the world's 192 nations. Single adults head up about 48.3 percent of the nation's households, and make up 42 percent of the nation's full-time workforce.

Delaying age of marriage, increased incidence of cohabitation and high divorce rates have created a cultural shift that is shaping new and emerging markets; requiring that marketers rethink their processes and approach. The social influence, distinctive characteristics and wallet full of discretionary income, make it necessary that businesses find means of reaching singles uniquely.

The singles lifestyle is not limited to nightclubs and online dating. Singles are looking for resources and information to help them live happier healthier lives. They desire satisfying relationships, personal growth, success, group activities, and ways to cultivate meaningful relationships. Hence, the increasing popularity of dating services should come as no surprise. They're a result of sweeping demographic change in our society. Career demands, hectic lifestyles and the changing role of women in the workplace have created a need for different ways to find and select a mate. Dating is not a trend or a fad, it's an evergreen necessity. Chadwick Martin Bailey Research indicates that in 2010, 17% of couples who married met on a dating site, online dating has become an integral part of everyday life.

Recent years have seen a massive cultural shift in consumer behavior and expectations due to social media. Consumers today expect more from businesses. In a social media economy consumers pay for experiences and today's consumer craves a dynamic community that sparks ‘spontaneous and natural interactions’ not a static product that's more like a full-time job. For example communities such as dating websites today are a collection of millions of profiles that users have to search through to find the right ‘one’. These dating websites require users to complete long questionnaires and then users are sent candidates that the matchmaking site considers suitable. Online daters tend to be busy professionals who find this approach to be impersonal, frustrating and time consuming.

Currently there is no central place to find resources, specials and events specifically for singles, and singles are often apprehensive of going to places alone. What is needed is a system and method by which singles find resources, such as local events on their phones, they can also see profiles of other event attendees, motivating them to do the things they love to do without the fear of doing it alone. The system and method disclosed herein satisfies that need by applying social media functionality and mobile phone convenience with a topic search engine to offer a personal, convenient way for community members to meet while naturally interacting with their environment.

### SUMMARY OF THE INVENTION

To address the requirements described above, the present invention discloses a topic-based method and apparatus for inter-contacting at least a portion of a plurality of users of an open network including a first user and a second user. In an exemplary embodiment, the method comprises the step of accepting first user information from a first user, wherein the first user information comprises first user demographic information and first desired contact demographic information describing a first contact desired by the first user to be chosen by a search from among the network of users. The method further comprises the step of accepting second user information from a second user, wherein the second user information comprises second user demographic information, the second user demographic information including information associating the second user with at least one of a plurality of topics, and second desired contact demographic information about a second contact desired by the second user to be chosen by a search from among the network of users. The method further comprises the steps of registering the first user and the second user in the network of the plurality of users and accepting an topic search request from the first user, wherein the topic search request comprising at least one topic search parameter. The method further comprises the steps of generating a topic search result that comprises at least one topic matching the topic search parameters and an identifier the second user if (1) the second user demographic information matches the at least one topic result, (2) the first desired contact information matches the second user demographic information, and (3) the second desired contact information matches the first user demographic information. Finally the method further comprises transmitting the topic search result to the first user. In another embodiment, the system or apparatus comprises a means for performing the above operations.

### BRIEF DESCRIPTION OF THE DRAWINGS

Referring now to the drawings in which like reference numbers represent corresponding parts throughout:

FIG. 1 is a diagram illustrating one embodiment of a topic based social search system (TSSE) and related elements;

FIG. 2 is a diagram illustrating one embodiment of exemplary method steps that can be used by the TSSE;

FIG. 3A is a diagram presenting one embodiment of how the result of a simple event search may be presented;

FIG. 3B is a diagram illustrating an exemplary embodiment of a user interface or screen 350 presented in response to a search for a venue;

FIG. 4A is a diagram illustrating exemplary steps that can be performed to narrow the topic search request according to further first desired contact information from the first user;

FIG. 4B is a diagram illustrating one embodiment of how user matches may be presented;

FIG. 5 is a diagram presenting illustrative steps that can be used to provide additional information regarding the second user identified in the topic search result;

FIG. 6 is a diagram illustrating exemplary steps that can be used to allow the first user to contact the second user;

FIG. 7 is a diagram illustrating an exemplary embodiment of steps that can be used to obtain automated personal concierge services;

FIG. 8A is a diagram showing one embodiment of a user interface for accepting the concierge service request and specifying the concierge service request parameters;

FIG. 8B is a diagram illustrating one embodiment of a simple concierge plan display;

FIG. 9 is a diagram illustrating how concierge planning may also allow the user to generate their own string of temporally adjacent activities, events or venues;

FIG. 10A is a diagram illustrating exemplary operations that can be used to request a commercial transaction with a venue, event, or vendor of an activity;

FIG. 10B is a diagram illustrating an exemplary gifting user interface screen; and

FIG. 11 is a diagram illustrating an exemplary computer system 100 that could be used to implement elements of the present invention.

### DETAILED DESCRIPTION OF PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

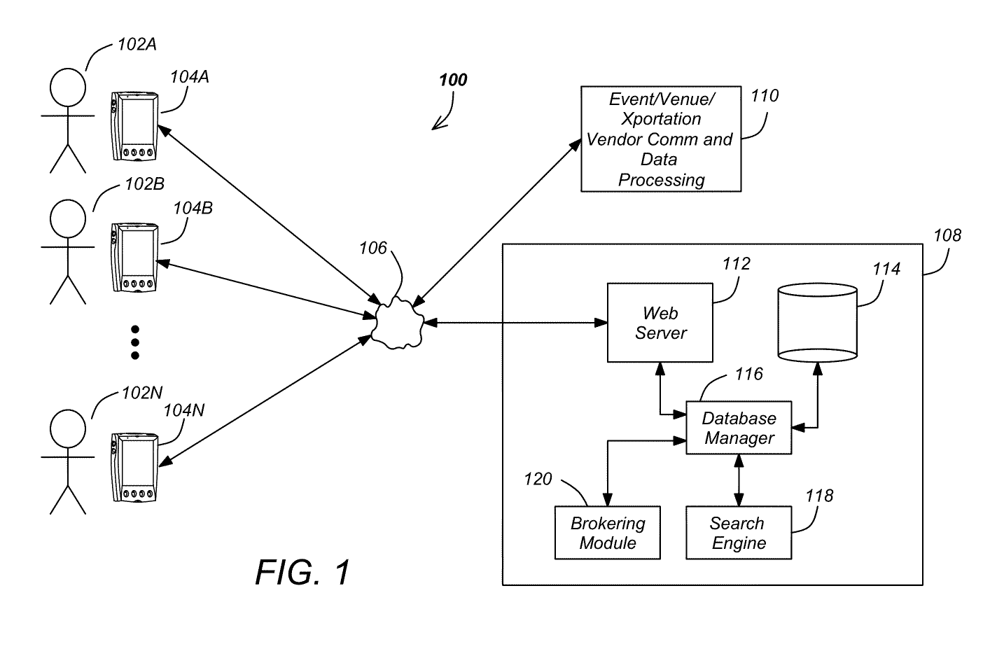

FIG. 1 is a diagram illustrating one embodiment of a topic based social search system (TSSE) 108 and related elements 100. Users 102A-102N (hereinafter alternatively referred to as user(s) 102 communicate with the TSSE 108 via communication devices 104A-104N (hereinafter alternatively referred to as communications device(s) 104 and a communications medium 106. The communications devices 104 may comprise a cellphone, smartphone, processing system such as a home computer, laptop computer, or tablet, or other processing devices such as personal data assistants. The communications medium 106 can include the Internet, the public-switched telephone network (PSTN), 3G, 4G, short message service (SMS) or any combination of communication media that by themselves, or together, permit two way communications between the users 102 and the TSSE108. For example, communications from the TSSE 108 to the users 102 may be accomplished via one communication medium, while communications from the users 102 to the TSSE 108 may be accomplished via another.

The TSSE 108 comprises a web server 112 for accepting data and commands from communications devices 104. The web server 112 may also accept data and commands and provide data and commands to similar devices 110 that perform data communications and processing for events and venues. A database manager 116 communicatively coupled to the webserver 112 and a database 114 accepts data ad commands from the webserver, and using such data and commands, directs a search engine 118 to search the database 114 to generate responses to user 102 and event 110 queries. The TSSE 108 also comprises a brokering engine 120 that brokers between event/venue communication and data processing systems 110 and the TSSE 108 to perform tasks such as purchasing tickets to events and making reservations at venues.

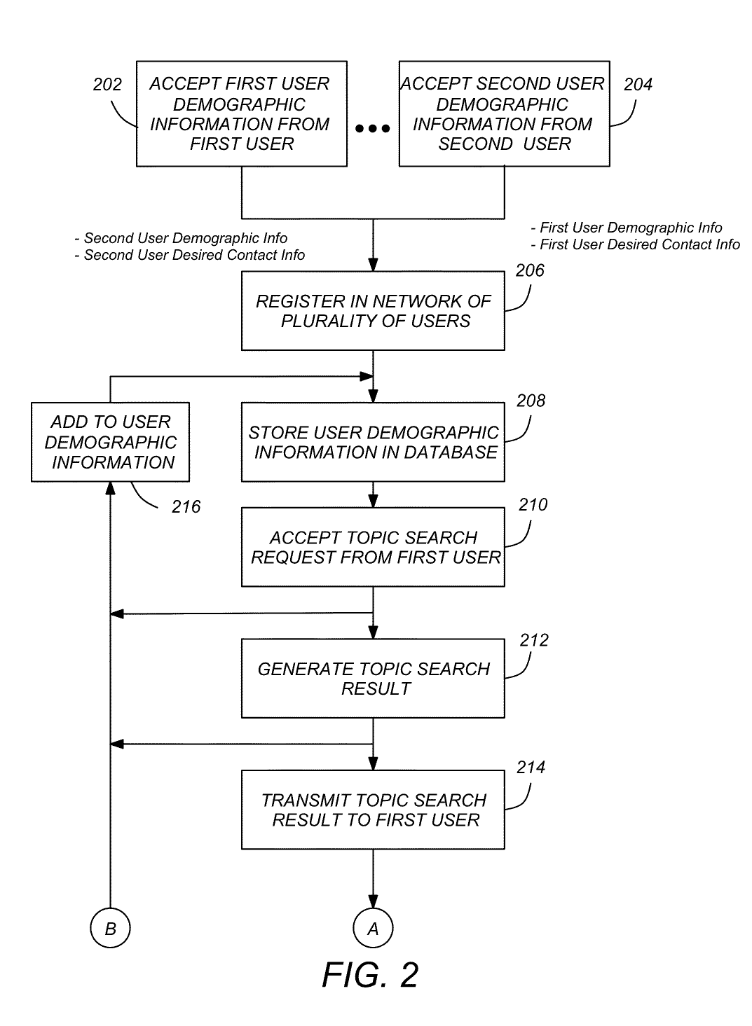

FIG. 2 is a diagram illustrating one embodiment of exemplary method steps that can be used by the TSSE 108. In block 202, first user information is accepted from a first user 102A. The first user information includes first user demographic information, which can include any combination of the first user's name, age, height, weight, ethnicity, residence location, occupation, income, interests, likes, and dislikes. First user demographic information may also include a photo (e.g. jpeg) of the first user 102A, and privacy preferences. The first user information also includes first desired contact information that describes a first user contact to be chosen by a search from among the network of users 102. For example, the first desired contact information may include the age, height, weight, ethnicity, residence location, occupation, income, interests, likes and dislikes of a person in the user network that the first user 102A would like to meet. In one embodiment, the network of users is an “open network” in the sense that a first user 102A may contact a second user 102B without prior permission from the second user 102B. In other words, unlike users 102A and 102B do not have to be “friends” in the FACEBOOK sense before they may communicate with one another through the user network.

In one embodiment, the first user information is entered into the communication device 104A, transmitted via the communication medium 108 to the web server 112 of the TSSE 108. The first user information is used to register the first user in a network of users comprising users 102A-102N, as shown in block 206, and stored in the database 114 under the control of the database manager 116 as shown in block 208. Block 204 illustrates analogous operations being performed for second user information accepted from a second user 102A using a second user device 104A. As was the case with the first user information, the second user information includes both demographic information (e.g. second user demographic information) and desired contact information about a contact desired by the second user to be chosen by a search from among the network of users.

In block 210, a topic search request is accepted from the first user communications device 104A. The entered topic search request may be added to the first user demographic information, as shown in block 216. Other user entered information, including all user input provided to the TSSE 108 may be processed and added to the user demographic information for the associated user, thus allowing this data to augment the user demographic information to better characterize the associated user and their preferences. The topic search request may comprise one or more topic search parameters such as keywords describing characteristics of the topic in which the first user 102A is interested. Examples of topics, topic search parameters, and topic search results are further discussed below.

In block 212, the search engine 118 generates a topic search result. The topic search result includes a topic matching the topic search parameters. Unless otherwise stated, “matching,” as used herein indicates that the topic sufficiently satisfies the search parameter(s) provided in the search request. Such search parameters may be hard search parameters that must be satisfied by the topic (e.g. an event with an admission price under $10) or soft search parameters (e.g. an event with an inexpensive admission price). Search parameters may also be prioritized according to other inputs provided by the user (e.g. price may be prioritized over convenience or seating). The topic search result may also comprise one or more of the network of users. For example, the topic search result may comprise the second user if three things are true: (1) the first desired contact information matches the second user demographic information, (2) the second desired contact information matches the first user demographic information, and (3) the second user demographic information matches the at least one topic result. Specific examples are further described below.

In block 214, the topic search result is transmitted to the first user communication device 104A.

### Event Searching

In one embodiment, the topic search provided by the first user comprises an event search. For example, the first user 102A may want to attend an event that they are already aware of, and simply enter keywords describing the event into the first user communications device 104A, requesting information regarding the particular event. Specifically, if the desired event were a Green Day concert, the user may simply enter “Green Day” as keywords. From the user's demographic information in the database 114, the search engine 118 can search for events related to Green Day near the first user's location. If a concert is scheduled, the topic result will comprise information regarding the Green Day concert. Importantly, the search engine also searches for other users in the network whose demographic information matches the Green Day concert at the location, and also whose desired contact information matches the first user demographic information and whose demographic information matches the first user's desired contact information. Such other user could be another user who is scheduled to attend the Green Day concert, which has purchased a ticket to attend the Green Day concert, or even another user who has also searched for information about the Green Day concert. For example, suppose first user 102A is Tom. Tom's first demographic information indicates that he is a 200 pound, 32 year old, 6′5″ male advertising executive in Los Angeles that likes Cajun food and makes over $150,000 a year, and his first desired contact information indicating that he is interested in meeting a 25 and 35 years old, 5′9″ to 6′0″ tall female weighing between 130 and 140 pounds that likes punk music. Suppose further that second user 102B is Wendy. Wendy's first demographic information indicates that she is a 34 year old 5′10″ 125 pound woman that likes punk music, and her second desired contact demographic information indicates she is interested in meeting any male over 6′ tall and 34 or more years old with an annual income of at least $100,000 a year. An ordinary dating service may match Tom and Wendy, based up the matching of their demographic information and their desired contact information, at which point, Tom and Wendy may contact one another and arrange for a date. However, the TSSE 108 allows Tom to search for an event he is interested in, and see other network users who not only match is demographic and personal preference information, but have also have demographic information that matches the event search outcome. So when Tom receives the search result, he not only receives information about the event itself, but information identifying other users in the network who are a personal match and who also are associated with the event in a socially relevant way (for example, Wendy's demographic information may indicate that she has purchased a ticket to the event, planned on attending the event, liked the event, or simply searched for the same event. Thus, Tom now not only has discovered an event his is interested in, he has also discovered a person with matching requirements who is attending or likely to attend the same event.

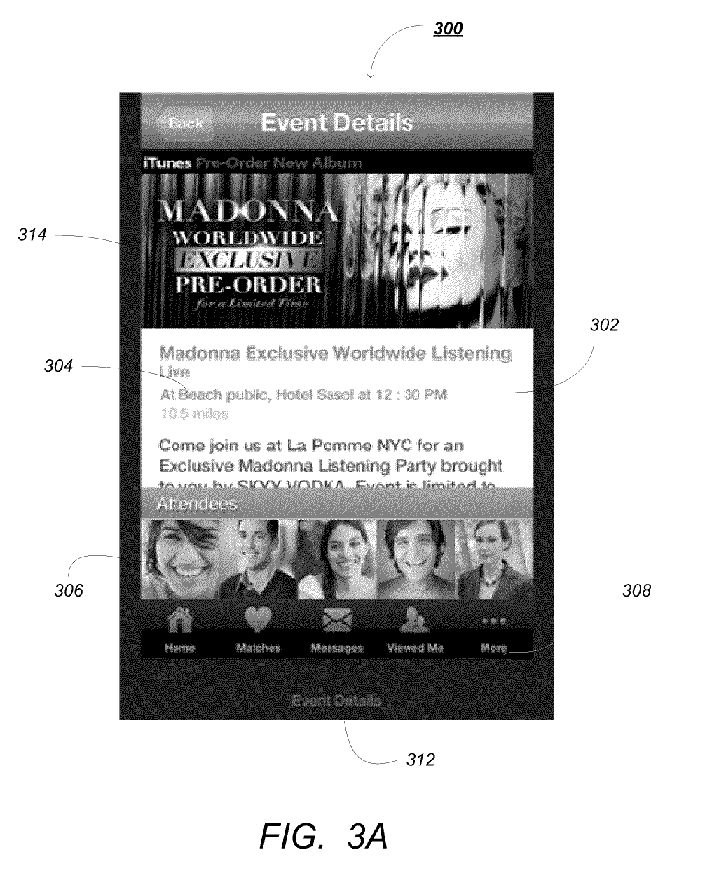

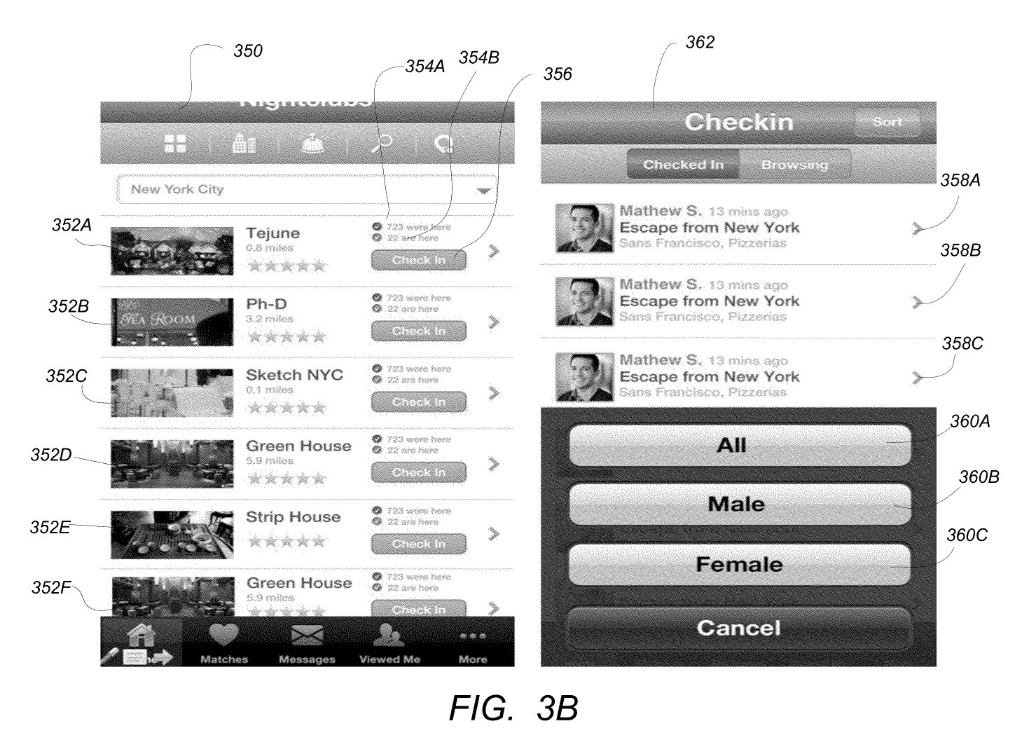

FIG. 3A is a diagram presenting one embodiment of how the result of a simple event search may be presented. A description of the event can be presented in one portion 302 of the display, with a link to the venue 304 at which the event will take place. Other users in the network matching the event 310 are also presented in another portion 306 of the display. The first user 102A may have specified that they are only interested in user who are attending the event (as in the illustrated embodiment), or users matching the event in other ways may be shown as well. More users in the network matching the event can be viewed by selecting the “more” control 310, and further event details can be obtained by selecting the “event details” control 312. The first user 102A may also order or pre-order tickets to the event by selecting control 314. Control 314 may be a control that is provided with all events (thus permitting tickets to be ordered), or may be only offered to user network members.

The first user 102A may also enter keywords and other parameters so as to find an event or venue of interest. For example, the first user 102A may want to attend a concert and the selection of which concert they attend may be based more on the other people attending rather than the concert itself. The first user 102A may then enter an event search specifying the date and time, and the search engine 118 may provide a plurality of events satisfying the search criteria. The first user may investigate each to determine which other network users matching the first user's desired contact demographic information (and how many) and determine which of the events to attend based on that information.

FIG. 3B is a diagram illustrating an exemplary embodiment of a user interface or screen 350 presented in response to a search for a venue. In particular, the first user 102A has entered a search for nightclubs near the first user's location. The topical search results present a plurality of nightclubs satisfying the topic search, each presented in a separate portion 352A-352F of the screen 350. Each of the portions also may include one or more indicator 354A and 354B indicating the association of other users 102 with the venue. Indicator 354A indicates which other users 102 in the user network have checked into the venue at one time or another, while indicator 354B indicates which other users 102 are currently at the venue. These results can be presented for all other users 102 in the network or only other users 102 having demographic information matching the desired contact demographic information of the searching user and or for which the searching user's demographic information matches the demographic information of the other user(s). The searching user 102A (e.g. the user that requested the search) may select check the appropriate control 354 or the right arrow to view screen 362, which presents thumbnails and/or profiles 358A-358C of the other users who are at the venue (as indicated by a recent check-in) or have been at the venue at some time in the past (as indicated by a past check in). The searching user 102 may also optionally check into the venue by selecting check-in control 356. Users 102A may set preferences to control which other members can see whether they are checked in to the venue or have done so in the past. Such preferences can be membership based (e.g. everyone, premium members, or verified members), or based on other parameters (e.g. only matching users or matching users with further characteristics).

As described further below, the user may then narrow down the user profiles presented to include only male users (by selecting the male control 360B), only female users (by selecting the female control 360C) or all users by selecting the all control 360A. The “Browsing” control may also be used to determine which other users in the network are browsing the same venue at the same time as the searching user 102A. The first user may also elect to narrow the number of matching second users are presented by entering further first desired contact demographic information. For example, if the first user search for the Green Day concert provided over 100 matching second users, first user may want to filter those 100 matching second users to find those with further desired contact demographic characteristics. So, returning to the previous example of Tom and Wendy, if 200 other matching second users were provided with the search result, Tom may narrow the search to include only blondes or females who live closer to him, are closer to his age, or never divorced.

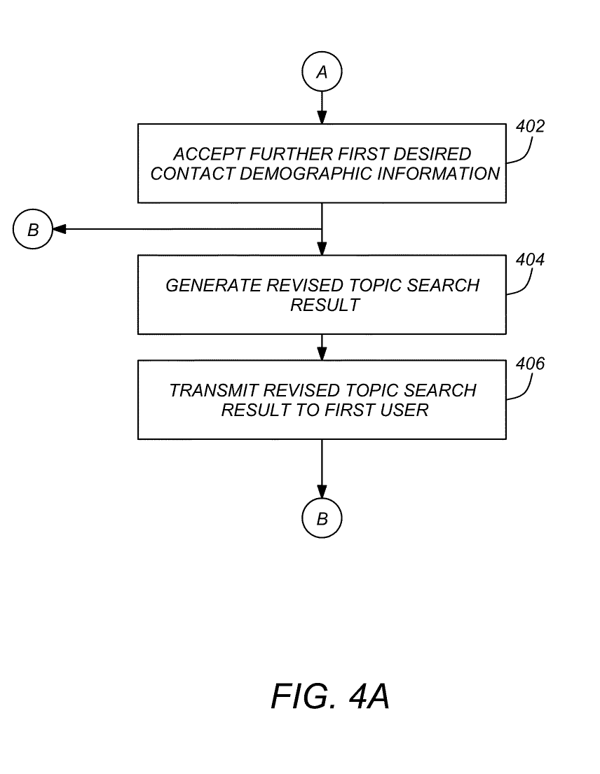

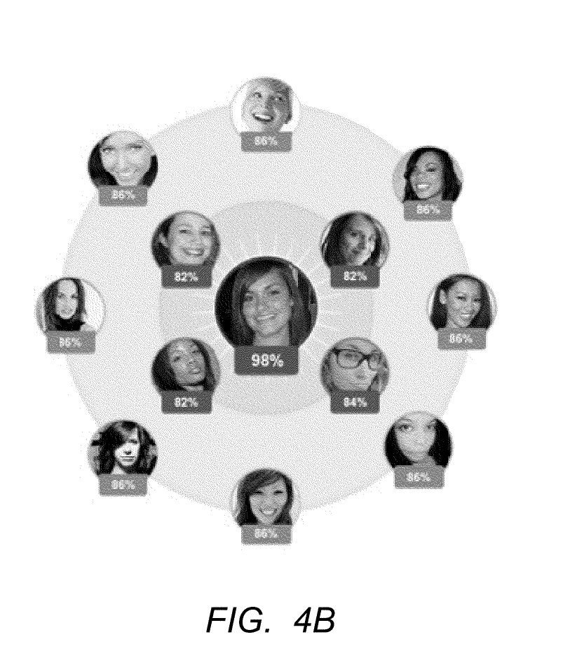

FIG. 4 is a diagram illustrating exemplary steps that can be performed to narrow the topic search request according to further first desired contact information from the first user. In block 402, further first desired contact demographic information is accepted. The further first desired contact demographic information includes further information regarding the first user's desired contact, for instance, in the example provided above, that Tom is interested in blondes that live closer to him. This further first desired contact demographic information may also be used to update the first user demographic information, as indicated by the branch to connector “b”. In block 404, a revised topic search result is generated using the further desired contact demographic information, and the result is transmitted to the first user 102A, as shown in block 406. Although the diagram illustrates the further first desired contact demographic information as being accepted after the initial topic search result is provided to the first user 102A, the data may be accepted before the first search result is provided. For example, the first user 102A may specify, as a part of the topic search, that they are looking for matching users meeting the further first desired contact demographic information in addition to the first desired contact demographic information. Users matching the first user 102A may be presented in an interface such as the interface shown in FIG. 4B, with the closest matches appearing toward the center of the concentric circles.

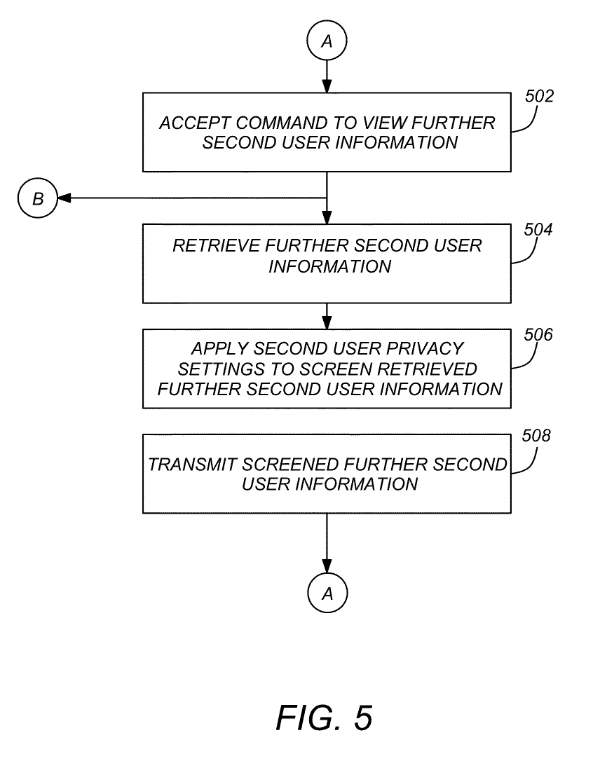

FIG. 5 is a diagram presenting illustrative steps that can be used to provide additional information regarding the second user identified in the topic search result. In block 502, a command is accepted to view further second user information. In block 504, the search engine 118 retrieves the requested further second user information, and in block 504, the second user's privacy settings are applied to generate screened further second user information. The resulting screened further second user information is transmitted to the requesting first user 102A, as shown in block 508.

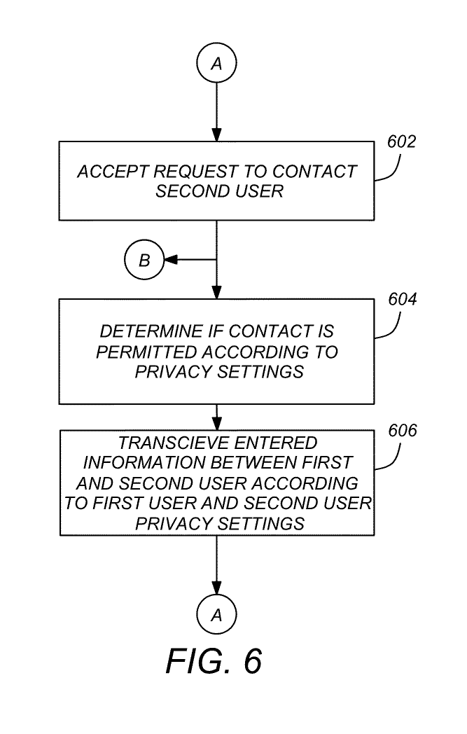

FIG. 6 is a diagram illustrating exemplary steps that can be used to allow the first user 102A to contact the second user 102B. In block 602, a command is accepted from the first user 102A to contact the second user 102B. In block 604, a determination is made as to whether the requested contact is permitted according to the privacy settings of the second user 102B. If the privacy settings permit the contact, information between the first user 102A and the second user 102B is transceived, as shown in block 606. This information may be a chat, e-mails or messages.

### Activity Searching—Personal Concierge Service

The TSSE 108 can also be used to provide an automated personal concierge service, in which a plurality of temporally proximate or adjacent activities are planned for the first user, using first user preferences, first user demographic information, and optionally, first user desired contact demographic information and/or the desired contact demographic information of other users 102 in the user network.

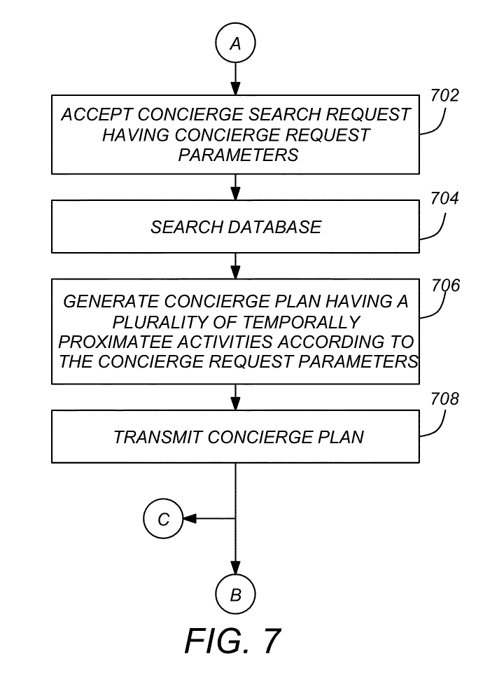

FIG. 7 is a diagram illustrating an exemplary embodiment of steps that can be used to obtain automated personal concierge services. In block 702, a concierge search request having concierge search request parameters is accepted.

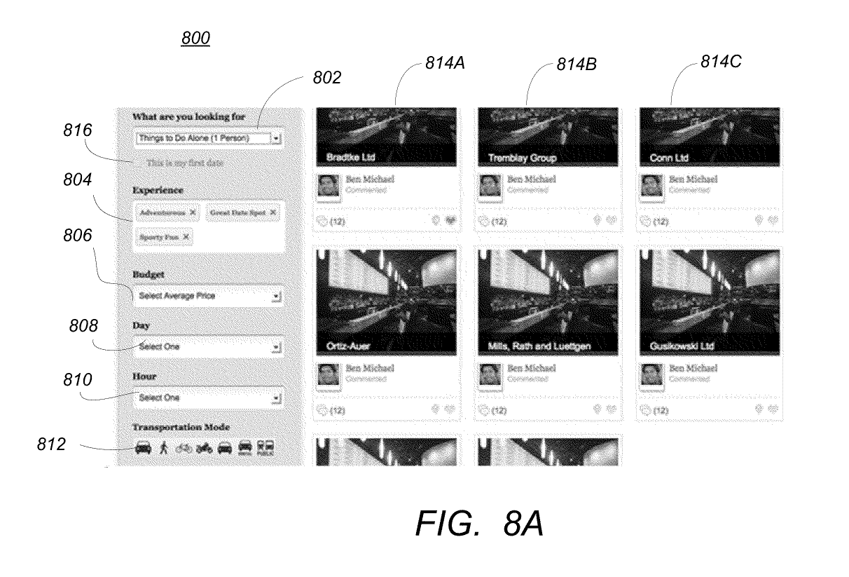

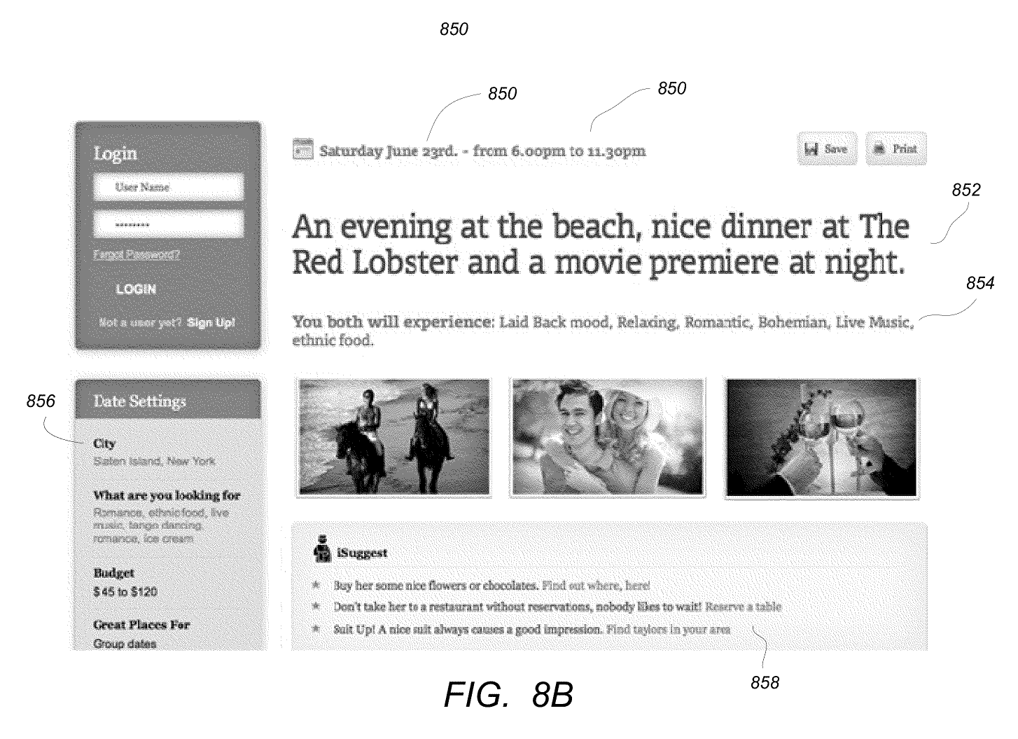

FIG. 8A is a diagram showing one embodiment of a user 102 interface 800 for accepting the concierge service request and specifying the concierge service request parameters. First input control 802 allows the user 102 to specify what participant category of concierge service they are interested in. Concierge service participant categories can include, for example, (1) things to do alone (2) things to do with another member of the user network, (3) things to do with another person who is not a member of the user network, and (4) things to do with N people, M of which are members of the user network, where M and N can be specified to be any number greater than one. An input box 816 is also provided if the user 102 is interested in concierge services for a first date. Second input control 804 allows the user 102 to specify one or more concierge service experience categories, which may include, for example, one or more activities that are adventurous, sporty, or conducive to dating. In one embodiment, the user specifies more than one experience category, with the result chosen to balance all of the selected experiences. A third input control 806 is provided to allow the user to enter a budgetary parameter, which may be input as a not to exceed monetary amount, or may be selected from a different levels of budget (e.g. 10-$50, $51-$100, $101-$200, etc.). A fourth input control 808 allows the user 102 to specify the date or date range of the experience (e.g. Dec. 31, 2013 through Jan. 1, 2013) or even the day of the week (for example, Friday, thus providing the user 102 with suggested activities for the coming Friday and other Fridays as well. A fifth input control 810 allows the user to enter the time interval of the planned activities. If the date extends through two days, the user may enter the beginning and ending time and date, as they would with a calendaring application such as OUTLOOK. Finally, a sixth input control 812 allows the user 102 to select a transportation mode for use during the planned activities. This could include walking, auto, bicycle, motorcycle, cab, rental car, or public transportation such as bus or rail.

Returning to FIG. 7, in step 704, the search engine 118 searches the database to identify events and activities that are candidate events and activities for the concierge search request response. The search engine 118 then performs a search of the database 114 to identify candidate activities, events, and venues for those activities that fall within the temporal (date and time) and experience parameter requirements, and provides the results to the database manager 116. Some or all of the information regarding availability and scheduled times for events and activities may be resident in the database 114 and updated on a frequent basis, or may be searched for and obtained in response to the first user's concierge request. For example, the database manager 116, via the webserver 112 and communications medium 106, can regularly request updated schedules and seat availability for events, venues and activities, store that information in the database 114, and use that information in generating a response to the first user's concierge request. Or, the database manager 116 may store possibly stale data regarding schedules and availability, and obtain updated information after the event, activity or venue has been identified as a candidate for the concierge request response, and it is determined that the information stored in the database 114 may be too stale for use. Further, event, venue and activity schedules may be updated less frequently than availability information. Some possible events, venues, and activities can also be identified or excluded using the budget parameters. This may be appropriate in situations wherein the least expensive item or activity in the event, venue, or activity exceeds a budget amount, for example, the total budget allocated to the concierge plan. For example, if Tom was trying to plan a first date with Wendy and wanted to spend less than $200, attending a Rolling Stones concert may be eliminated as a candidate event if the lowest admission price exceeded $100 per person. In cases costs are not fixed and are dependent upon availability (e.g. seats to a concert) budgeting restrictions may be applied after availability has been determined and confirmed, for example, by contacting the venue to determine seat availability. After available candidate events, activities, and venues have been determined, the beginning and end times of such events, activities, and venues are determined. This could include, for example, restaurant opening and closing hours, show times, and tour times. This information is used to generate a string of candidate activities, events and venues that can be strung together with adequate travel time (as determined according to the transportation mode parameters entered into control 812) between such events. Transportation to/from and in between events is selected according to the selected transportation mode, and transportation scheduling information available from the data processor associated with the transportation mode. For example, subway or train schedules and seat availability may be considered, as well as traffic conditions for the times of day and days of the week that such travel will take place.

The resulting events, venues, and activities (and transportation) are strung together to generate one or more candidate concierge plans, as shown in block 706. Those concierge plans are then transmitted to the first user 102A, as shown in block 708.

FIG. 8B is a diagram illustrating one embodiment of a simple concierge plan display 850, illustrating a plan that includes an evening at the beach, dinner at a restaurant (RED LOBSTER) and a movie premier, as shown in title summary 852. The experience categories input into the concierge plan are presented in experience summary 854. As noted, the concierge plan was selected based on the first user's desire for a laid back, relaxing, bohemian evening with live music and ethnic food, and for parameters including the city, budget, and other input parameters, as shown in date settings box 856. Suggestion box 856, offers commercial transactions related to the activity, as described further below.

In one embodiment, one of the choices input to input control 802 is to plan an activity or series of activities that are to be undertaken with another user 102 of the user network, for example, the second user 102B identified by the topic search described above. In which case, the first user 102A identifies the second user 102B (or the identification is implicit from other first user 102A input), and the TSSE 108 generates a concierge plan of a string of activities that are based on the second user information about the second user 102B. In one embodiment, the TSSE 108 prioritizes the concierge plan to include activities that both the first user 102A and the second user 102B are likely to enjoy, thus essentially planning a date that both the first user 102A and the second user 102B will enjoy, even if they are not as good of a match as initially believed.

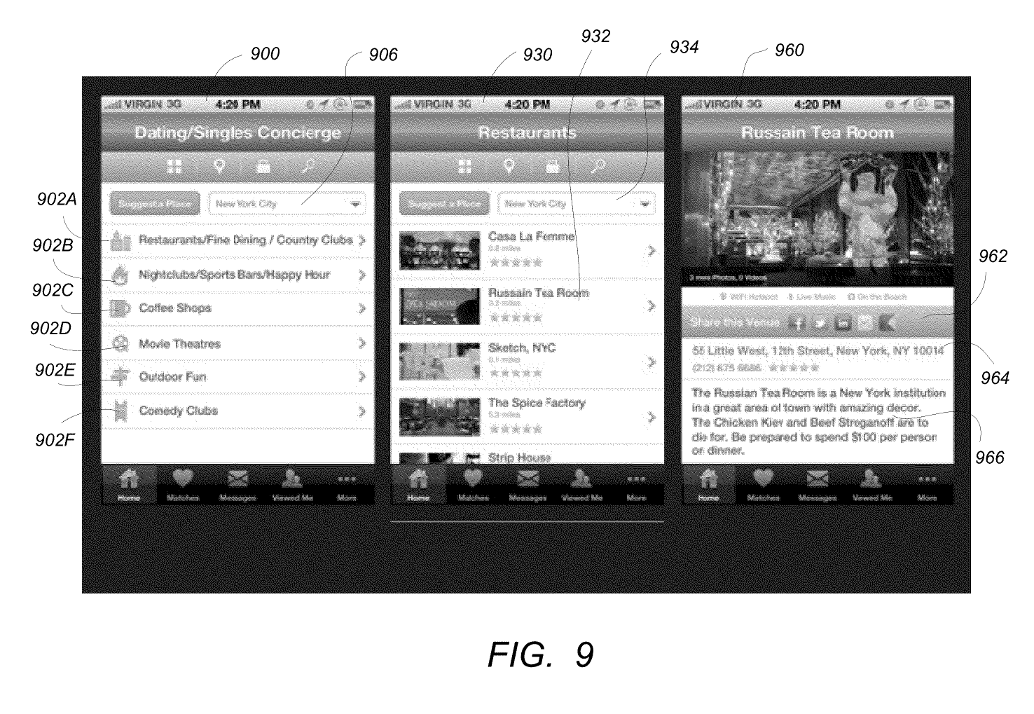

FIG. 9 is a diagram illustrating how concierge planning may also allow the user to generate their own string of temporally adjacent activities, events or venues. In the illustrated embodiment, the first user 102A is presented with a first screen 900, which includes a control for entering the location or area of interest. In the illustrated example, the location or area of interest is New York City, but narrower or broader locations may be presented, or the user may manually enter the location. Different categories of 902A-802F venues are presented. Such venue categories may include restaurants 902A, nightclubs 902B, coffee shops 902C, movie theaters 902D, outdoor venues 902E, or comedy clubs 902F. The user selects the venue category, and a second screen 930 showing options for the selected venue category is presented. In the illustrated embodiment, the user has selected the restaurant category 902A, so screen 930 presents a plurality of restaurants. In one embodiment, the plurality of restaurants includes any restaurant that the first user 102A may like (based on their first user demographic information), or restaurants that are selected based not only upon the first user's demographic information, but also matches between the first user's desired contact demographic information and other user's demographic information and between the first users demographic information and other users' desired contact demographic information. In other words, the restaurants presented may be only those for which matching other users are also associated (e.g. by being at the restaurant, having eaten there, or planning to eat there) with the restaurant, or may be prioritized in presentation according to matching other users (e.g. those restaurants with the greatest number of matching uses are presented first). Further, the number of matching other users may be presented in screen 930.

When presented with screen 930, the user may select another location using input control 934, or may select one of the venues (in the illustrated case, restaurants) for further investigation, which action presents a third screen 960 devoted to that particular venue is displayed. In the illustrated embodiment, the user has selected a restaurant called “Russian Tea Room,” and information about this venue is displayed. This includes the address (which may be a control 964, which, when selected, brings the user to the restaurant's website), ratings, telephone number, and description 966. A control 962 may also be provided by which the user may share the venue with another person using a social networking system such as FACEBOOK or TWITTER, or ONE2ONE. A further control may be provided that allows the user to request in a commercial transaction with the venue, for example to order food to go or to make a reservation.

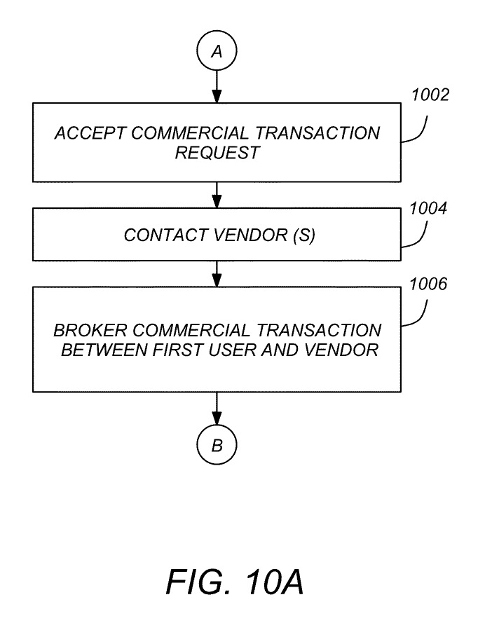

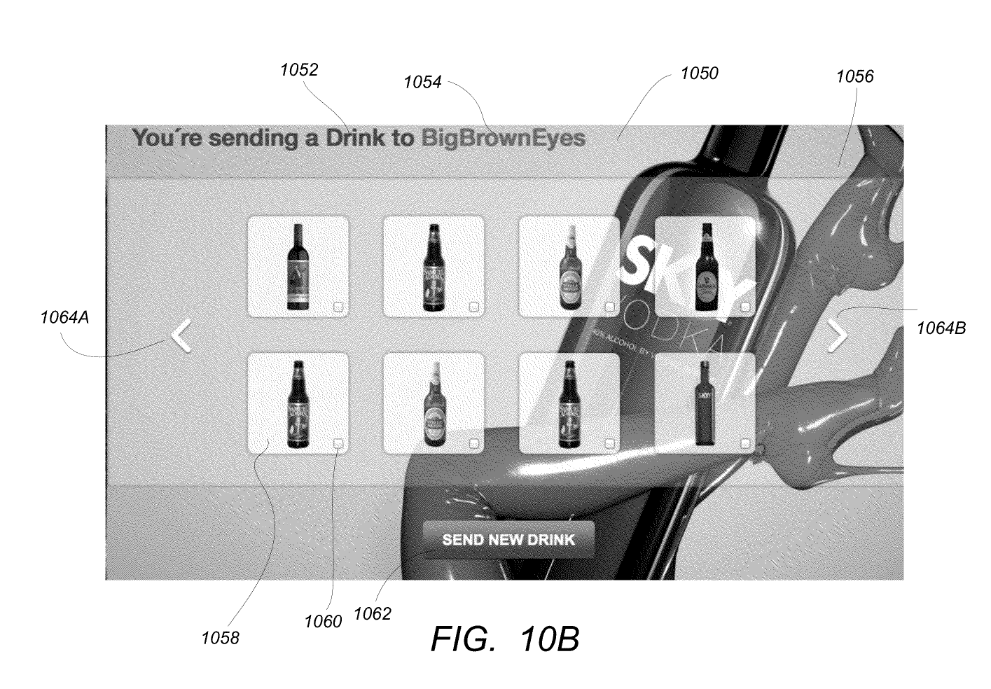

FIG. 10A is a diagram illustrating exemplary operations that can be used to request a commercial transaction with a venue, event, or vendor of an activity. In block 1002, a commercial transaction request is received. The commercial transaction request could be a request relating to a single venue, event, or activity, or a string of temporally proximate venues, events, or activities. In block 1004, the vendor(s) for the venue, event or activity are contacted, and a session is initiated either between the TSSE 108 and the vendor 110. Using the brokering module 120, the TSSE 108 interfaces with the vendor 110 and the user 102, brokering one or more transactions between the user 102 and the vendor 110 to purchase a ticket, make a reservation or any other action required to permit the planned activity to take place.

Other commercial transactions are also possible, for example, the first user 102A may wish to “gift” the second user 102B with flowers. This may be accomplished anonymously by selecting the desired user's profile (e.g. by selecting thumbnail 306 and when the user's profile is presented on a screen, selecting a control to indicate that the first user 102A desires to send a gift to the identified user. A further display may be presented to offer a number of different gifts to be purchased for the identified user. Vendors of such gifts may share revenue with the proprietor of the TSSE 108 for the privilege of being a suggested vendor of the gift. Alternatively, the first user 102A may already have navigated to the vendor of a gift, and the user may select a control on a screen presented for that vendor, and later select which other user 102 the first user 102A would like to purchase the gift for. In still another embodiment, when the first user 102A is viewing the screen presented for a vendor, one or more second users having second user identification information matching the first user's desired contact demographic information and for which the second user's desired contact demographic information matches the first user's demographic information may be presented. These one or more further users may be further narrowed to include other users whose demographic information indicates they have an interest in a product or service from the vendor. This permits the first user to see other users who might be a romantic match and who might also be interested in a gift from that particular vendor.

FIG. 10B is a diagram illustrating an exemplary gifting user interface screen 1050. The screen 1050 includes an indication 1054 of the recipient user 102 of the gift (in this case, a user with the name “BigBrownEyes,” the category of gift 1052 (in this case, a drink), and a selection of possible gifts 1058, each with an associated control, such as control 1060. The user 102 can send one or more gifts to the recipient by selecting one or more of the controls 1060 and selecting control 1062. Other gifts or categories of gifts can be presented for selection via navigation controls 1064A and 1064B.

While the foregoing description has been provided using examples of singles searching for activities, events, and venues to meet or interact with other singles, the systems and methods described are also applicable to users of any marital or relationship status. For example, in one embodiment, the first user 102A may define their demographic information to include the fact that they are married to another user 102, and search for activities, events, and venues that are appropriate for both the first user 102A and their spouse. In this case, the search engine 118 takes the user information of both the first user 102A and the first user's spouse into account when finding appropriate events or other users or couples of users in finding appropriate events, venues, and activities. Further, users may identify themselves as couples and the desired contact information for those couples is used in generating the topic search results as described above.

### Hardware Environment

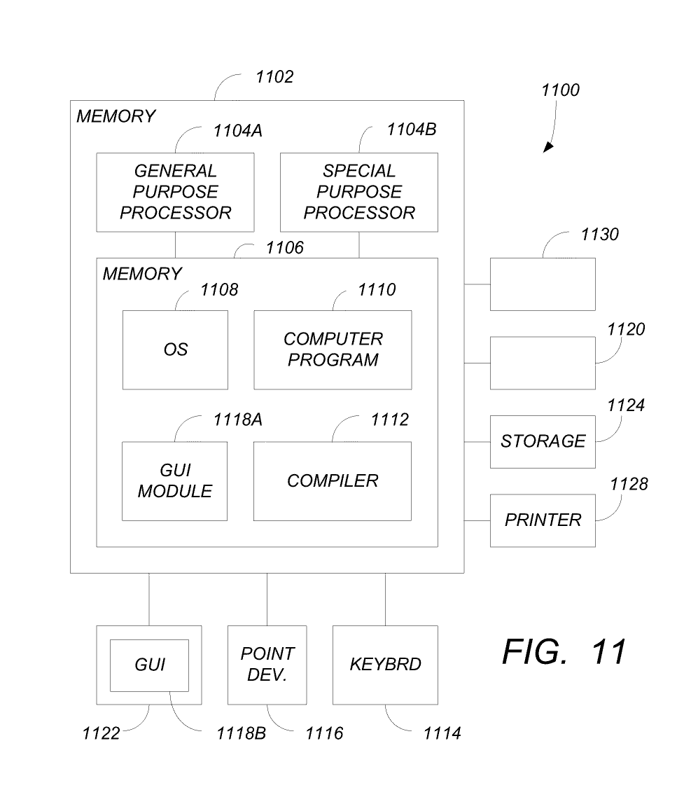

FIG. 11 is a diagram illustrating an exemplary computer system 100 that could be used to implement elements of the present invention, including the communication devices 104, the web server 112, database manager 116, brokering module 120, search engine 118 and vendor communication and data processing 110. The computer 1102 comprises a general purpose hardware processor 1104A and/or a special purpose hardware processor 1104B (hereinafter alternatively collectively referred to as processor 1104) and a memory 1106, such as random access memory (RAM). The computer 1102 may be coupled to other devices, including input/output (I/O) devices such as a keyboard 1114, a mouse device 1116 and a printer 1128.

In one embodiment, the computer 1102 operates by the general purpose processor 1104A performing instructions defined by the computer program 1110 under control of an operating system 1108. The computer program 1110 and/or the operating system 1108 may be stored in the memory 1106 and may interface with the user and/or other devices to accept input and commands and, based on such input and commands and the instructions defined by the computer program 1110 and operating system 1108 to provide output and results.

Output/results may be presented on the display 1122 or provided to another device for presentation or further processing or action. In one embodiment, the display 1122 comprises a liquid crystal display (LCD) having a plurality of separately addressable pixels formed by liquid crystals. Each pixel of the display 1122 changes to an opaque or translucent state to form a part of the image on the display in response to the data or information generated by the processor 1104 from the application of the instructions of the computer program 1110 and/or operating system 1108 to the input and commands. Other display 1122 types also include picture elements that change state in order to create the image presented on the display 1122. The image may be provided through a graphical user interface (GUI) module 1118A. Although the GUI module 1118A is depicted as a separate module, the instructions performing the GUI functions can be resident or distributed in the operating system 1108, the computer program 1110, or implemented with special purpose memory and processors.

Some or all of the operations performed by the computer 1102 according to the computer program 1110 instructions may be implemented in a special purpose processor 1104B. In this embodiment, some or all of the computer program 1110 instructions may be implemented via firmware instructions stored in a read only memory (ROM), a programmable read only memory (PROM) or flash memory within the special purpose processor 1104B or in memory 1106. The special purpose processor 1104B may also be hardwired through circuit design to perform some or all of the operations to implement the present invention. Further, the special purpose processor 1104B may be a hybrid processor, which includes dedicated circuitry for performing a subset of functions, and other circuits for performing more general functions such as responding to computer program instructions. In one embodiment, the special purpose processor is an application specific integrated circuit (ASIC).

The computer 1102 may also implement a compiler 1112 which allows an application program 1110 written in a programming language such as COBOL, C++, FORTRAN, or other language to be translated into processor 1104 readable code. After completion, the application or computer program 1110 accesses and manipulates data accepted from I/O devices and stored in the memory 1106 of the computer 1102 using the relationships and logic that was generated using the compiler 1112.

The computer 1102 also optionally comprises an external communication device such as a modem, satellite link, Ethernet card, or other device for accepting input from and providing output to other computers.

In one embodiment, instructions implementing the operating system 1108, the computer program 1110, and/or the compiler 1112 are tangibly embodied in a computer-readable medium, e.g., data storage device 1120, which could include one or more fixed or removable data storage devices, such as a zip drive, floppy disc drive 1124, hard drive, CD-ROM drive, tape drive, or a flash drive. Further, the operating system 1108 and the computer program 1110 are comprised of computer program instructions which, when accessed, read and executed by the computer 1102, causes the computer 1102 to perform the steps necessary to implement and/or use the present invention or to load the program of instructions into a memory, thus creating a special purpose data structure causing the computer to operate as a specially programmed computer executing the method steps described herein. Computer program 1110 and/or operating instructions may also be tangibly embodied in memory 1106 and/or data communications devices 1130, thereby making a computer program product or article of manufacture according to the invention. As such, the terms “article of manufacture,” “program storage device” and “computer program product” or “computer readable storage device” as used herein are intended to encompass a computer program accessible from any computer readable device or media.

Of course, those skilled in the art will recognize that any combination of the above components, or any number of different components, peripherals, and other devices, may be used with the computer 1102.

Although the term “computer” is referred to herein, it is understood that the computer may include portable devices such as cellphones, portable MP3 players, video game consoles, notebook computers, pocket computers, or any other device with suitable processing, communication, and input/output capability.

### CONCLUSION

This concludes the description of the preferred embodiments of the present invention. The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A topic based method of inter-contacting at least a portion of a plurality of users of an open network including a first user and a second user, comprising the steps of:
accepting first user information from a first user, the first user information comprising:
first user demographic information; and
first desired contact demographic information describing a first contact desired by the first user to be chosen by a search from among the network of users;
accepting second user information from a second user, the second user information comprising:
second user demographic information, the second user demographic information including information associating the second user with at least one of a plurality of topics; and
second desired contact demographic information about a second contact desired by the second user to be chosen by a search from among the network of users;
registering the first user and the second user in the network of the plurality of users;
accepting a topic search request from the first user, the topic search request comprising at least one topic search parameter;
generating a topic search result, the topic search result comprising:
at least one topic matching the topic search parameters; and
an identifier the second user if:
the second user demographic information matches the at least one topic result;
if the first desired contact information matches the second user demographic information; and
if the second desired contact information matches the first user demographic information;
transmitting the topic search result to the first user.

2. The method of claim 11, wherein the step of generating a topic search result comprises the steps of:
generating a topic search result matching the topic search parameters;
determining if the second user demographic information matches the topic search result;
if the second user demographic information matches the topic search result, determining if the first desired contact information matches the second user demographic information and the second desired contact information matches the first user demographic information; and
if the first desired contact information matches the second user demographic information and the second desired contact information matches the first user demographic information, including an identifier of the second user to the topic search result.

3. The method of claim 2, wherein the identifier of the second user is included in the topic search result only if the second user demographic information matches the at least one topic result, the first desired contact information matches the second user demographic information, and the second desired contact information matches the first user demographic information.

4. The method of claim 2, wherein:
at least a portion of the plurality of f users has further user demographic information including information associating that further user with the topic search result;
the topic search result comprises at least some of the portion of the plurality of further users; and
the method further comprises the steps of:
accepting further first desired contact demographic information.

5. The method of claim 4, wherein the further first desired contact demographic information is accepted before transmitting the topic search result to the user.

6. The method of claim 11, wherein:
the topic search request is an event search request, the event search request comprising event search parameters comprising at least one of:
identity of the event; and
a cost of the event;
the one topic search result comprises an event matching the event search parameters;
the second user demographic information comprises:
information associating the second user with the matched event, comprising at least one of:
the second user attending the event; and
the second user planning to attend the event.

7. The method of claim 11, further comprising the steps of:
accepting a request for a commercial transaction from the first user associated with the identified event; and
brokering the commercial transaction between the first user and a vendor of the identified event.

8. The method of claim 11, wherein:
the topic search request is a venue search request, the venue search request comprising venue search parameters comprising at least one of:
identity of the venue;
a cost of the venue;
the topic search result comprises a venue matching the event search parameters;
the second user demographic information comprises:
information associating the second user with the matched venue, comprising:
attendance at the venue by the second user; and
an input from the second user liking the venue.

9. The method of claim 11, wherein:
the topic search request is a concierge search request, the concierge search request comprising concierge request parameters including at least one of:
a number of participants;
a category of experience;
a cost;
a temporal interval; and
a transportation mode;
generating concierge plan having a plurality of temporally proximate activities according to the concierge request parameters.

10. The method of claim 9, wherein:
the number of participants is at least two, the participants including the first user and the second user, and the concierge plan is further generated according to the first user demographic information and the second user demographic information.

11. A topic based social search system for inter-contacting at least a portion of a plurality of users of an open network including a first user and a second user, comprising:
a web server for accepting first user information from a first user, the first user information comprising:
first user demographic information; and
first desired contact demographic information describing a first contact desired by the first user to be chosen by a search from among the network of users;
wherein the web server further accepts second user information from a second user, the second user information comprising:
second user demographic information, the second user demographic information including information associating the second user with at least one of a plurality of topics; and
second desired contact demographic information about a second contact desired by the second user to be chosen by a search from among the network of users;
wherein the web server further accepts a topic search request from the first user, the topic search request comprising at least one topic search parameter;
a database manager for registering the first user and the second user in the network of the plurality of users;
a search engine for generating a topic search result, the topic search result comprising:
at least one topic matching the topic search parameters; and
an identifier the second user if:
the second user demographic information matches the at least one topic result;
if the first desired contact information matches the second user demographic information; and
if the second desired contact information matches the first user demographic information;
wherein the web server further transmits the topic search result to the first user.

12. The system of claim 11, wherein the search engine generates the topic search by:
generating a topic search result matching the topic search parameters;
determining if the second user demographic information matches the topic search result;
if the second user demographic information matches the topic search result, determining if the first desired contact information matches the second user demographic information and the second desired contact information matches the first user demographic information; and
if the first desired contact information matches the second user demographic information and the second desired contact information matches the first user demographic information, including an identifier of the second user to the topic search result.

13. The system of claim 12, wherein the identifier of the second user is included in the topic search result only if the second user demographic information matches the at least one topic result, the first desired contact information matches the second user demographic information, and the second desired contact information matches the first user demographic information.

14. The system of claim 12, wherein:
at least a portion of the plurality of further users has further user demographic information including information associating that further user with the topic search result;
the topic search result comprises at least some of the portion of the plurality of further users; and
the web server further accepts further first desired contact demographic information.

15. The system of claim 14, wherein the further first desired contact demographic information is accepted before transmitting the topic search result to the user.

16. The system of claim 11, wherein:
the topic search request is an event search request, the event search request comprising event search parameters comprising at least one of:
identity of the event; and
a cost of the event;
the topic search result comprises an event matching the event search parameters;
the second user demographic information comprises:
information associating the second user with the matched event, comprising at least one of:
the second user attending the event; and
the second user planning to attend the event.

17. The system of claim 11, wherein:
the web server further accepts a request for a commercial transaction from the first user associated with the identified event; and
the system further comprises a brokering module for brokering the commercial transaction between the first user and a vendor of the identified event.

18. The system of claim 11, wherein:
the topic search request is a venue search request, the venue search request comprising venue search parameters comprising at least one of:
identity of the venue;
cost of the venue;
the topic search result comprises a venue matching the event search parameters;
the second user demographic information comprises:
information associating the second user with the matched venue, comprising:
attendance at the venue by the second user; and
an input from the second user liking the venue.

19. The system of claim 11, wherein:
the topic search request is a concierge search request, the concierge search request comprising concierge request parameters including at least one of:
a number of participants;
a category of experience;
a cost;
a temporal interval; and
a transportation mode;
the database module further generates concierge plan having a plurality of temporally proximate activities according to the concierge request parameters.

20. The system of claim 19, wherein:
the number of participants is at least two, the participants including the first user and the second user, and the concierge plan is further generated according to the first user demographic information and the second user demographic information.
